(19) United States
(12) Patent Application Publication
(10) Pub. No.: US 2004/0085367 A1
(43) Pub. Date: May 6, 2004

(54) Association of multiple objects in a table cell with visual components

(76) Inventor: Richard Hagarty JR., Roseville, CA (US)

Correspondence Address: HEWLETT-PACKARD COMPANY, Intellectual Property Administration, P.O. Box 272400, Fort Collins, CO, 80527-2400, US

(21) Appl. No.: 10/286,666

(22) Filed: Nov. 1, 2002

(51) Int. Cl. G09G 5/00

(52) U.S. Cl. 345/854; 345/856

(57) ABSTRACT

A computer-implemented method of allowing a user to select a visual component for one of a plurality of navigation objects in a table cell. The method includes using a label and pointers to the navigation objects to allow the user to select one of the navigation objects. The user can navigate directly from the table to view information pertinent to the selected navigation object.

### BACKGROUND OF THE INVENTION

Data networks and data storage systems commonly provide different functionalities for different users. As such systems grow increasingly complex, it becomes increasingly important for system administrators to be able to maintain and extend them without difficulty. It also is important for system developers to be able to provide needed system functionality quickly and easily.

A Java Core framework (Java core) can be utilized in a user interface (UI) framework to provide an infrastructure for component-related features that enable a system developer to provide a component-based application architecture. Dynamic component loading enables extensible applications that can determine their scope of functionality at runtime. Component brokering and lookup allow components to use one another's services. Automatic update and downloading of components allow self-updating of client/server relationships as well as just-in-time component delivery. Java core enables the building of applications that are collections of components. Java core also enables the rapid development of custom applications that can be built by “mixing and matching” preexisting components to deliver desired functionality.

Java core components can be extended by phluid, by Hewlett-Packard Company, assignee of the present invention. Phluid (“platform for hierarchical data user interface development”) is an integration framework for building Java applications with graphical user interfaces. Java core components extended by phluid can be particularly useful in developing a graphical user interface (GUI) for user applications. Such applications typically make use of GUI visual components such as icons, trees and lists, to display data and menus and to allow a user to switch between different contexts for displaying and utilizing data. To facilitate user access to such features, a navigation class may be defined that represents an association between objects in a data model and a visual component that can be selected by a user. Such a class can be instantiated to produce a navigation object.

A navigation object can be rendered in an application as a label, with both a device icon and name, that can appear in a navigation tree and/or in a panel table. Navigation objects may be stored in table cells so that, for example, sorting and summarizing of associated data can be performed. If a navigation object is rendered as a label in a panel table, a user may right-mouse click on the object label to perform context-sensitive actions. A user may also double-mouse click on an object label when displayed in a navigation tree and cause the navigation tree to switch to the selected object and to show one or more panels associated with the object.

In some situations, more than one navigation object may be stored in a table cell. For example, in a GUI used for storage area network management, a group of navigation objects associated with similar storage devices may be stored in a cell that is associated with the devices as a group. In such a case, a string list of device names may be used to represent the navigation objects stored in the cell. When the string list is displayed, a user can read it to determine which devices are included in the cell. In this case, however, the string list represents more than one navigation object. The user, therefore, does not have direct access to each of the navigation objects via the table cell to display and/or perform context-sensitive actions.

### SUMMARY OF THE INVENTION

The present invention, in one embodiment, is directed to a computer-implemented method of allowing a user to select a visual component for one of a plurality of navigation objects in a table cell. The method includes using a label and pointers to the navigation objects to allow the user to select one of the navigation objects.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a screen view of a graphical user interface (GUI) according to one embodiment of the present invention;

FIG. 2 is a functional block diagram of a UI framework according to one embodiment;

FIG. 3 illustrates packages, classes and interfaces forming the UI framework according to one embodiment;

FIG. 4 is a flow diagram of steps performed when launching a BaseUI component according to one embodiment;

FIG. 5 illustrates a navigation object according to one embodiment;

FIG. 6 is a screen view of a graphical user interface (GUI) according to one embodiment;

FIG. 7 is a flow diagram of a method of storing navigation objects in a table cell according to one embodiment;

FIG. 8 is a screen view of a graphical user interface (GUI) displaying a tooltip according to one embodiment;

FIG. 9 is a flow diagram of a method of displaying a popup menu of context-sensitive actions for a navigation object stored in a table cell according to one embodiment;

FIG. 10 is a screen view of a graphical user interface (GUI) displaying a pull-right menu and a popup menu according to one embodiment;

FIG. 11 is a flow diagram of a method of displaying a visual component associated with a data model via a navigation object according to one embodiment;

FIG. 12 is a screen view of a graphical user interface (GUI) displaying a navigation object selection dialog box according to one embodiment; and

FIG. 13 is a screen view of a graphical user interface (GUI) displaying a visual component according to one embodiment.

### DETAILED DESCRIPTION OF THE INVENTION

The following description is merely exemplary in nature and is in no way intended to limit the invention, its application, or uses. Although certain embodiments of the present invention are described with reference to a phluid layer on top of Java core components, the invention is not so limited. Embodiments are contemplated in which Java and/or other object-oriented programming languages and systems are used and/or extended to provide the functionality described in relation to the present embodiments.

Additionally, the present invention is described below in conjunction with storage management applications for storage area networks (SANs), so that features of such applications may provide a context in which to illustrate embodiments of the present invention. Skilled artisans will appreciate, however, that the present invention is not limited to use in connection with SANs. It also should be noted that although embodiments are described herein relative to a user interface framework, the invention is not so limited. It should be evident to those skilled in the art that embodiments of the present invention can be practiced in connection with other systems and/or networks in which a GUI is utilized.

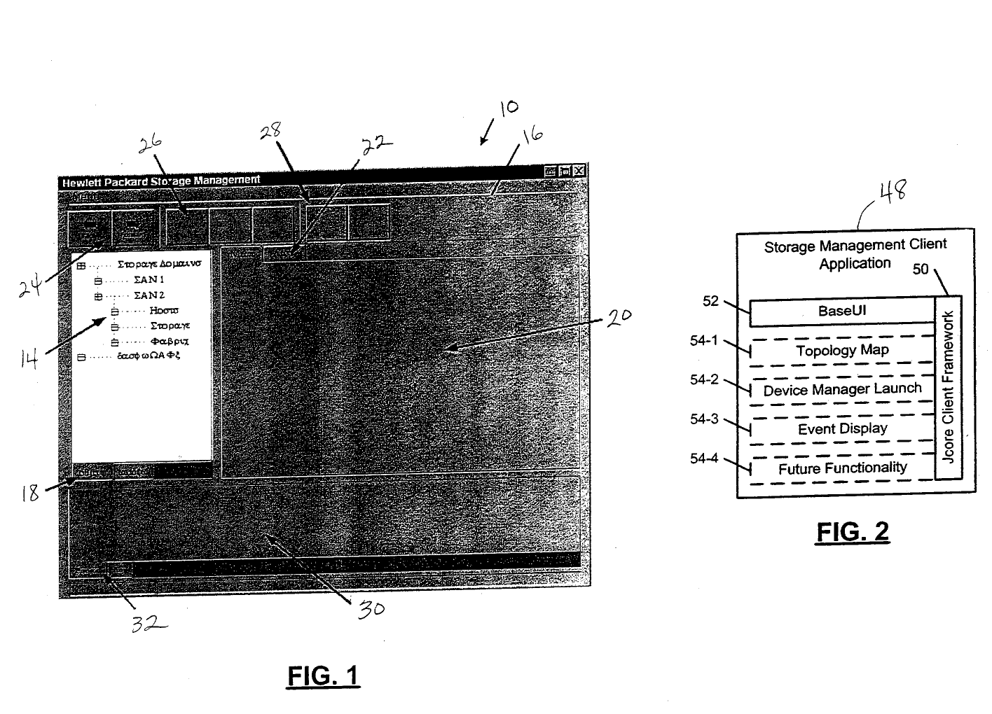

Referring now to FIG. 1, a user interface (UI) framework provides a platform for building Java applications with a browser-style graphical user interface (GUI) 10. The UI framework allows independent software components to be integrated into a single GUI-based application. The browser-style GUI 10 includes a hierarchy of objects in a navigation tree 14 in a main window 16. Alternate versions of the tree list 14 may be selected using tabs 18. A view panel 20 displaying data relative to a currently selected tree object is presented beside the tree 14 in the main window 16. The view panel 20 may be adjusted using tabs 22. Additionally, browser-style navigation is provided with back/forward buttons 24. Context dependent and independent buttons 26 and 28 are also provided. A log panel 30 provides a “log” type display, for example, for displaying events. A tab 32 allows adjustment of the information displayed in the log panel 30.

The UI framework provides an extensible software platform that promotes encapsulation of specific product functions into independent components. Thus, functionality can be varied in different installations of the same application. Features of the UI framework include a common navigation model, single point of access for related tools, and context-specific launch points. The UI framework provides services that are common to many application implementations. These services include a main application frame, navigation, toolbars, menus, logging and alert output, options and configuration.

The UI framework is a Java class library that supports the GUI 10 by providing a set of tools built on Java Swing components. The UI framework integrates the functionality of multiple applications into a single client application. The design favors, but does not require, a reasonably tight integration of visual elements (e.g. different products can add items to the same menus, tree views, etc.). The UI framework builds upon functionality provided by a Java Core framework (Java core). Java core is a Java class library that provides a standard framework for the development of application functionality that is “plugged-in” to a distributed application.

Java core components resemble traditional Java applications and can create GUIs and perform console input and output. Java core components, however, do not implement a main( ) method. Instead Java core components implement a class that extends a Java core base component class. In this class, Java core components override a method called initialize( ). This method is the equivalent of an application's main( ). In this method, a component may create additional objects or start threads as necessary to perform the job of the component.

An entry is made in a component database (DB) file that causes the component to be dynamically loaded. This can be accomplished by “dropping in” a file with the right information and naming convention into an appropriate directory. Components are passed a Component Manager object in the initialize method. This object can be used by the component to obtain references to other peer components or to remote server components. Components are also passed a property tree that can be used to configure the behavior of the component, much like a command-line argument would be used to configure the behavior of an application.

Referring now to FIG. 2, architecture of the UI framework includes, for example, a storage management client application 48 that contains a Java core client framework 50. The client framework 50 connects to a storage management server (not shown) that provides data models for UI components. The framework includes a BaseUI component 52 and several additional client UI components 54. The BaseUI component 52 of the UI framework is a Java core component that provides the base application window 16 of FIG. 1 and a set of common UI services. The UI services include navigation, general configuration, toolbars, menu bars, help, and other GUI functionality such as depicted in FIG. 1.

The BaseUI component 52 need not provide any functionality specific to storage management and can be, for example, an empty shell. Other Java core components 54 that are part of the client framework plug into the BaseUI component 52 and can provide specific product functions and visual content. A plurality of products can share base application panels such as view panels 20 and log panels 30, or alternately can launch another tool with windows of the product. UI functions provided by storage node management (SNM) components 54 can be implemented with a set of Java core components that integrate with the BaseUI component. In one embodiment, SNM functionality includes topology maps, event display, and device management launch.

The BaseUI component 52 provides basic navigation of objects presented in the navigation tree and view panels. The BaseUI component 52 enables components to integrate popup menu items into tree and view panel objects. The BaseUI component 52 enables buttons to be added into the tool bar and menus to be added to the menu bar. The BaseUI component 52 enables components to display items in the log panel area and in a status bar area (not shown).

One service provided by the BaseUI component 52 is navigation of items selected by the user. The navigation tree, navigation controls, and view panel areas of the main application frame are visual components that handle navigation. The BaseUI component 52 maintains one or more hierarchies of navigation objects. Specifically and for example, a class NavObject is defined that represents an association between objects in a data model and a visual component that can be selected by the user. A navigation object (NavObject) is an instance of the class NavObject.

Nodes in the navigation tree visual component represent NavObjects. In one embodiment, the BaseUI component 52 does not create any NavObject objects directly—all NavObject objects in the application are passed to the BaseUI component 52 by other Java core client components 54. The underlying model for a NavObject can be any object. For example, the underlying model can be an object in a storage management data model such as a host or storage device. The model for a NavObject can also be a list of other NavObject items—e.g. one can represent the aggregate of all hosts in a storage domain, so that there can be a hosts node in the tree.

The view panel area of the application frame contains a visual component corresponding to a currently selected NavObject. A NavObject implementation has a factory method that provides one or more panels. If there is only one panel, the panel is displayed directly in the view panel area. If there is more than one panel, the panels are displayed as tabbed panels. In addition, other components can add panels to a NavObject display by registering as a ViewPanelContributor.

As shown in FIG. 1, NavObject objects can be organized hierarchically and presented in a navigation tree 14. There can be a plurality of NavObject trees in an application, each representing a separate context. Contexts can be used to distinguish between perspectives of similar NavObject hierarchies. For example, storage area network components can be presented in a topology context, where each node in the tree 14 represents a component in a topology. Another context could present the same devices in an “inventory” hierarchy, where folders represent groups of similar objects such as host, switches, etc. Contexts can be selected by the user with the navigation context tabs 18 in the navigation tree panel 14.

When a NavObject is selected as further described below, the BaseUI component 52 creates view panels for the object. The BaseUI component 52 can create a view panel by calling a method in the NavObject that returns the base view panels defined for the object. The BaseUI component 52 also can create a view panel by calling a method in all UI components that have registered as a ViewPanelContributor for the instance of the NavObject selected.

A NavObject implementation provides a set of base tabs. For example, a general storage device NavObject provides a panel that shows a graph of utilization and another that shows a list of logical unit numbers (LUNs). UI components add tabs to a specific NavObject by registering as a ViewPanelContributor and providing additional tabs. For example, a performance monitoring component registers to provide additional tabs to storage devices for which it has performance information.

A view panel 20 in one embodiment is represented by a Java JPanel object. In order to accommodate hyperlink style navigation through the contents of the view panel, the BaseUI component 52 provides a set of visual objects or components to represent a NavObject. These objects or components are selected for navigation and “right-clicked” to display the context sensitive or “popup” menu for the NavObject.

An example of a component that can be used to represent a NavObject is the NavObjectLabel class. This class is associated with a label that displays a name and icon of a NavObject. When such a label is clicked, the NavObjectLabel class sends a message to the BaseUI component 52 to select the NavObject associated with the label. Developers implementing a view panel 20 use the NavObjectLabel label to link contents of the panel to a NavObject. The BaseUI component 52 handles specific navigation functions. In addition to the NavObjectLabel class, table and list components also provide navigation facilities, as further described below.

NavObjects have a context sensitive popup menu. Default menu items include basic navigation operations like “view” and “view in new window.” In addition, UI components can register as a PopupContributor for a NavObject to add custom menu items. When, for example, an icon for a NavObject is selected with the right mouse button, the BaseUI component 52 creates a popup menu including default items and any items contributed by registered PopupContributor objects.

The log panel 30 is intended for custom displays that a UI component may place on the main window. Examples include event lists or output logs. To send data to the log panel 30, a UI component calls a method in the BaseUI component 52 and passes a Swing JPanel as a parameter. The UI component is responsible for handling all events on objects in the panel 30. If a plurality of components register a log panel with the BaseUI component 52, the tabbed pane 32 is used to allow the user to select a desired log panel.

The UI framework provides facilities for customization and configuration. These facilities include a global configuration data base and an application programming interface (API) that allows component developers to access configuration parameters.

In one embodiment, three separate Java core client components integrate storage node management functionality into the client application, by providing functions of topology maps 54-1, device management launch 54-2, and event display 54-3. The topology map component 54-1 presents maps of interconnected elements in a storage domain. The topology map component 54-1 creates a hierarchy of NavObject objects that correspond to one or more navigation trees in the storage node management application. These are added to a “topology” context in the BaseUI component 52. The view panel for each object is a Swing component that renders the corresponding map. Icons in the topology map panels are Swing components that fire navigation and selection events to notify the BaseUI component 52 of user activity. The BaseUI component 52 handles popup and drill-down selections through its navigation facilities.

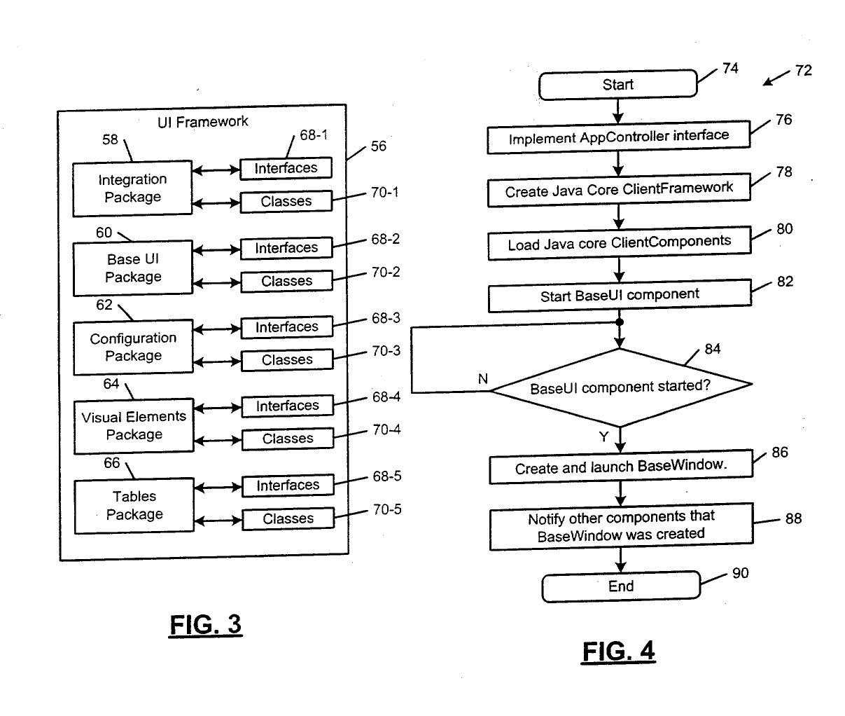

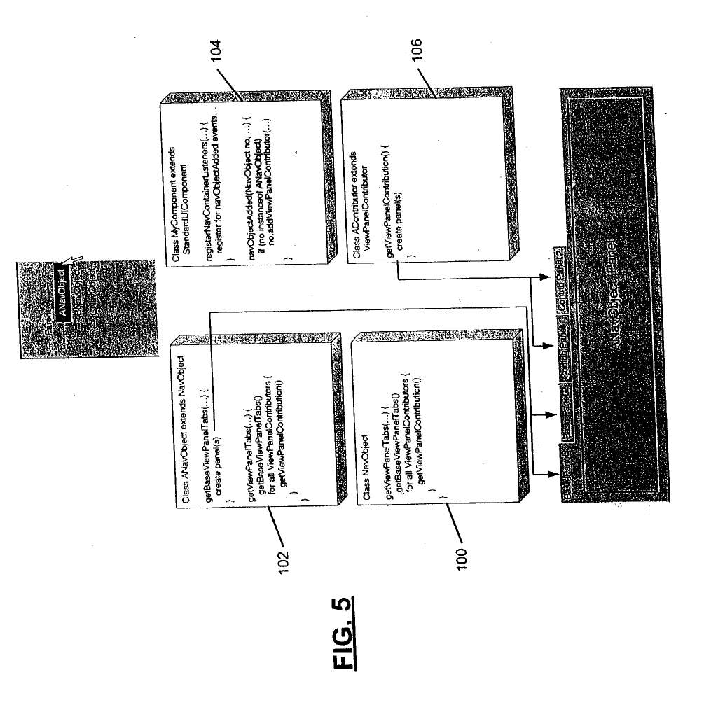

Referring now to FIG. 3, the UI framework 56 is implemented by a plurality of Java packages, each package including one or more interfaces and one or more classes. The packages include an integration or phluid package 58, a BaseUI or phluid.base package 60, a configuration or phluid.config package 62, a visual element or phluid.widget package 64, and a tables or phluid.widget.table package 66. The packages 58-66 contain classes 68-1, 68-2, . . . , and 68-n and/or interfaces 70-1, 70-2, . . . , and 70-n. As can be appreciated, fewer or additional packages may be used. The packages 58, 60, 62, 64 and 66 perform as a layer over and extend the Java core components.

### Phluid Package

The phluid package 58 is a UI framework package that defines core classes used for integration. The classes 70-1 in the phluid package 58 are not visible UI elements—they are used to define standard objects and the interfaces used to access underlying data structures of the UI framework.

### Phluid Package—Interfaces

The phluid package 58 includes the following interfaces 68-1: AppController is an interface for classes that control the behavior of a main application. BaseUI is an interface for applications that implement an application platform. Application components use this interface to integrate their GUI components into the main application. Config is an interface for access to general configuration information. Configuration parameters are properties organized hierarchically. Each child level is called a sub-config. Levels are delimited by a dot in the string representing the name.

MenuBarContributor is an interface for objects that contribute menus and menu items to the menu bar of application windows. MenuContainer is an interface that defines a “container” for menus. Note that this is not a visible component and is not related to the java.awt.Container or the java.awt. MenuContainer classes. A menu container contains the following standard menus: File menu, Edit menu, View menu, Tools menu and Help menu.

NavContainer is an interface that defines a “container” including a set of navigation contexts (a hierarchy of NavObjects). Note that this is not a visible component and is not related to the java.awt.Container class. NavObjectFilter is an interface for classes that are to distinguish between different types of NavObjects. NavObjectSelectionListener is an interface for classes interested in receiving notification that a user has selected a NavObject for viewing.

NavSelector is an interface for classes that control the selection of NavObjects for navigation. NavTreeEventListener is an interface for objects interested in knowing about NavTree events, such as expanding/collapsing of tree nodes, and keyboard events. PopupContributor is an interface for objects that add items to the popup menu for a NavObject. ViewPanelContributor is an interface for objects that add tabs to a NavObject view panel.

### Phluid Package—Classes

The phluid package 58 includes the following classes 70-1. CachedViewPanelTab is an abstract view panel derivative that provides a facility to cache its view panel instances as they are created, to save time when switching from one NavObject to another. EventMap defines events used by the framework for the component bootstrap sequence. Components that extend the StandardUIComponent class do not need to use this directly.

NavContext is a class that defines a context for a group of NavObjects. A context is hierarchical and can contain multiple roots. NavObjects is a context that can be flagged as primary or secondary. Secondary objects exist in the hierarchy but are not considered by TreeModel interface methods that this class implements. Therefore, secondary objects do not appear in JTrees.

As previously mentioned, NavObject is a class for objects that can be navigated by user actions. Note that a NavObject is not a visible component. This class creates an association between a data model and its visible UI components. This class implements Comparable so that representations of NavObjects can be easily sorted in tables, etc. NavObjectSelectionEvent is an event indicating a NavObject has been selected. NavObjectTreeNode maintains parent-child links in the tree hierarchy of a NavContext. Resource is used to manage UI resources. This class is almost identical to the standard Java ResourceBundle, except that it provides an additional method that allows the location of images to be specified in the resource bundle.

StandardUIComponent is a base class for Java core client components that have UI elements. This is provided as a convenience to developers. This class handles the details of the UI component bootstrap sequence. Application client components can extend this class. ToolGroup is a panel that displays a group of JComponents in the fashion of a tool bar. This class is named a “group” instead of “toolbar” so that it is not confused with Java Swing's JToolBar. ViewPanelTab is a class that defines a tab to be displayed in the view panel for a NavObject.

### Package Phluid.base

The phluid.base package 60 provides implementation of the BaseUI interface and supporting classes.

### Package Phluid.base—Interfaces

The phluid.base package 60 includes the following interfaces 68-2: ConnectionStatusListener is an interface for classes interested in receiving notification about a current state of connectivity between client and server applications. NavWindow is an interface for any window that has its own navigation state.

### Package Phluid.base—Classes

The phluid.base package 60 includes the following classes 70-2: AboutDialog is a JDialog that displays version information for all loaded Java core ClientComponents. AppWindow is a basic window suitable for use as the main application window. The BaseUI component 52 is a Java core client component that provides the BaseUI interface. StandardBaseUI is a class that implements the BaseUI interface. BaseWindow is a base window of the application. ChildWindow is a window that displays a NavObject separately from the BaseWindow for the application.

ContentPanel displays view panel(s) of a currently selected NavObject. NavButtons is a ToolGroup that displays back/forward/up navigation buttons. NavPanel is a JPanel that contains the NavTree. SelectionPoster is used to fire selection events from a Swing thread. StandardNavSelector is a standard implementation of the NavSelector interface that keeps a history of all selections to ensure that there is always a selected context and a selected NavObject in any context.

ToolPanel is a JPanel that contains all toolbar items. ViewMenu is a menu that deals with navigation functions, such as forward, back, up, etc. It also keeps a history log.

### Package Phluid.Config

The phluid.config package 62 defines implementations of a phluid.Config interface 68-3. A class 70-3, LocalPropertyDBConfig, implements the phluid.Config interface which can handle Java core PropertyDB objects.

### Package Phluid.widget

The phluid.widget package 64 is a root package for visual elements and supports classes that can be used to develop UI content.

### Package Phluid.widget—Interfaces

The phluid.widget package 64 includes the following interfaces 68-4: ProcessBusyIndicator is an interface for classes that need to display contributor information about any process that may currently be in a busy state (such as in a status bar). TableHeaderResizedListener is a listener that is notified when a table column header is resized. ToggleBoxSelectionListener is a listener that is notified when a ToggleBox state changes.

### Package Phluid.widget—Classes

The phluid.widget package 64 includes the following classes 70-4: BaseDialog is an extension of javaxswing.JDialog that provides methods and/or controls to simplify standard dialog creation. BrowserLauncher is a class that encapsulates the opening of a default web browser for a given URL. CheckBoxBox is a swing component that groups multiple JCheckBox components. CheckListPanel is a helper class to implement a JList with checkboxes inside a JScrollPane. ChooserPanel is a helper class that implements a standard “chooser” dialog, where there are two lists of items: a list of available items to select from, and a list of selected items. The items in the lists can be moved back and forth between the lists.

ControlButton defines standard control buttons. Cursors defines standard cursors, such as the cursor used when mouse is hovered over a NavObject. FormCancel is a Java key adapter that recognizes ESC key-press as a dialog cancellation action. FormColumn is a JPanel convenience wrapper, useful for building forms and dialog boxes. FormField is a widget useful for placing text fields into forms. FormLabel is a convenience JLabel wrapper that is useful for placing sized labels in forms. FormRow is a JPanel convenience wrapper useful for building forms and dialog boxes.

I18nOptionPane is an internationalized wrapper for JOptionPane.showMessageDialog( ) and JOptionPane.showConfirmDialog( ). NavObjectImageMap is an “image map” that associates regions of an image with NavObjects. Mouse events over the specified regions trigger appropriate actions (e.g. selections, popup menus). The class NavObjectLabel is a basic component for display of a NavObject that handles cursor change on mouse hover, selections, and popup menus.

NavObjectTable is a sortable table with various customizations for displaying cell data. This includes support for columns that contain NavObjects, columns that have a TableCellMap, and filtered data using the FilteredTableModel. NavTree is an extension of JTree that can be used to display a NavContext. The nodes of the tree are instances of NavObjectTreeNodes.

PropertyTable is a basic two-column table useful for displaying name/value pairs. Note that this class is not an extension of JTable. RadioButtonBox is a Swing component that groups multiple JRadioButton components, allowing only one to be selected at a time. ResizableLabel creates a resizable JLabel.

RolloverButton is a button that highlights when the mouse is over it. RolloverToggleButton is a toggle button that highlights when the mouse is over it. ShiftedIcon is an Icon that contains an offset value for customized placement. SmartPopupMenu is a JpopupMenu that automatically shifts its placement so that all of its contents are viewable (within the display bounds). Splash is a Utility class for creating application “splash” windows. StandardTable is a JTable that fires header resized events. SubtleBevelBorder is a border that is useful for highlighting buttons. SummaryPanel is a class for displaying a table and a summary row of JPanels that resize with the table. SwingWorker is an abstract class that can be subclassed to perform GUI-related work in a dedicated thread.

SynchronizedTableHeaderPanel is a panel with containers having a size that is synchronized with the column size of the specified table. There is no containing relationship between an instance of this class and a specified table. TableHeaderResizedEvent is an event that is fired when a user resizes a table column header. ToggleBox is a swing component that organizes multiple JToggleButton components in a horizontal row or vertical column. Methods are provided to control and query the states of buttons. An attribute controls whether multiple selections are allowed. ToggleBoxSelectionEvent is an event used to indicate a state change in a ToggleBox. ToolBarButton is a basic button for use in ToolGroups.

UpDownButton is a JPanel that simulates an up/down button and is usually associated with a text field that displays a number value. Pressing the up/down button changes the text field accordingly. URLLinkedLabel is an extension of JLabel that launches a browser with a certain URL when clicked with the mouse. WholeNumberField is a JTextField that accepts whole number values.

### Package Phluid.widget.table

The phluid.widget.table package 66 contains widgets specifically related to tables.

### Package Phluid.widget.table—Interfaces

The phluid.widget.table package 66 includes an interface 68-5, TableCellMap, that maps table cells to UI components.

### Package Phluid.widget.table—Classes

The phluid.widget.table package 66 includes the following classes 70-5: BooleanFilterOperation is used in determining whether a row should be added to a table. ChainedTableModelFIlter is used to determine whether a row should be added to a table. ColumnValueFilterExpression is used to determine whether a row should be added to a table. DefaultSummarizer is a class that returns a double value for Java primitive data type wrappers.

DefaultSummaryTableModel is a default table model for associating with a JTable. This class provides a solid implementation of the abstract SummaryTableModel. DefaultTableCellMap maps a table cell to a value. FilteredTableModel is used in determining whether a row should be added to a table. MultiFilteredTableModel is used in determining whether a row should be added to a table.

NavObjectTableCell is a table cell for NavObjects. NavObjectTableCell implements Comparable and sorts NavObjects based on a String returned from NavObject.getName( ). SortableTableModel is a table model that provides a method to sort rows. Each row is an instance of the inner class TableRow. Each element in the table can implement a Comparable interface for sorting. SummaryTableModel is a table model that is sortable and summarizable. Summarization functionality includes sum, averages, etc.

TableModelFilter provides a filtering mechanism to limit what is displayed in a table. TableModelFilterParseException is an exception thrown by the TableModelFilter.

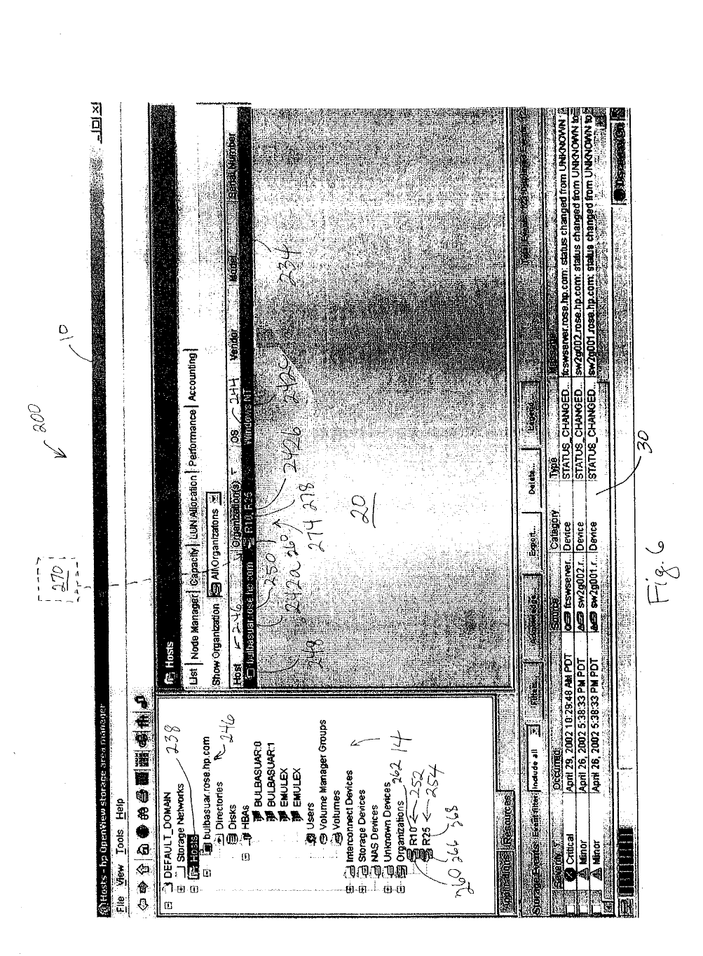

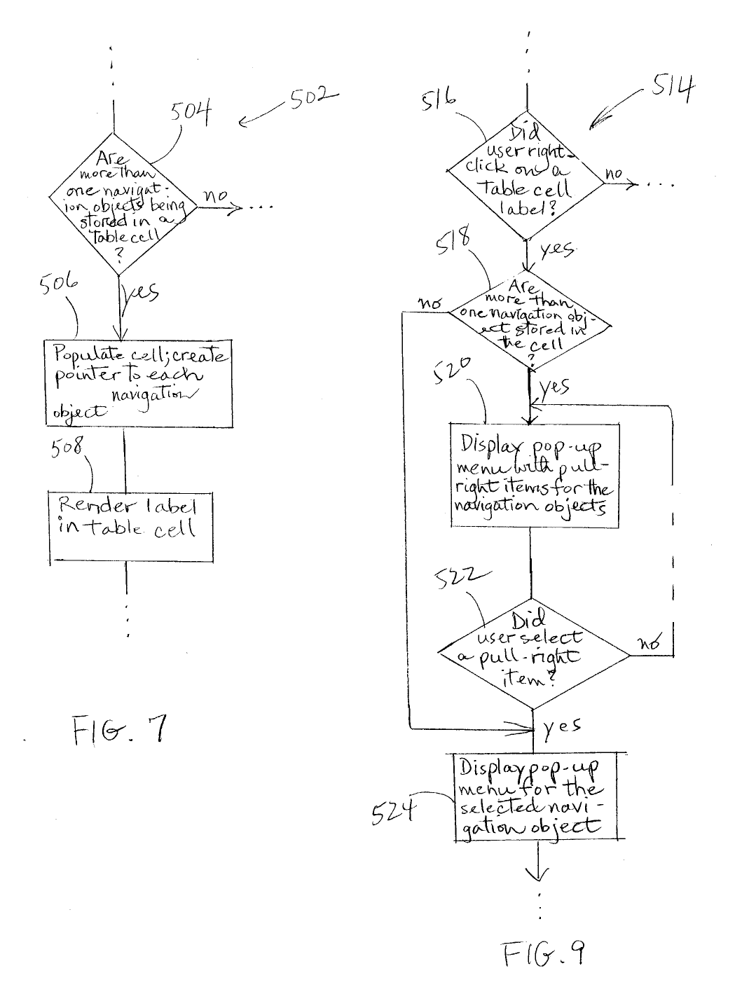

Referring to FIG. 4, the main application that is built upon the UI framework implements a method 72 that begins in step 74. In step 76, an AppController interface is implemented. In step 78, a Java core ClientFramework is created. In step 80, Java core ClientComponents are loaded. In step 82, the BaseUI component 52 is started. Once the BaseUI component 52 is started, the BaseUI component creates and shows the BaseWindow in step 86 and notifies interested listeners that the window has been created in step 88.

In one embodiment, all contributing components provide a UI class that extends the StandardUIComponent. This automatically registers the component as a Java core ClientComponent. As a StandardUIComponent, the contributing component implements several interfaces. Initialize( . . . ) is called by Java core when the component is loaded. RegisterNavContainerListeners( . . . ) is called by the BaseUI component 52 so that the component can register as a NavContainerListener. RegisterUI( . . . ) is called by the BaseUI component 52 so that the component can register any UI contributors (eg. for the tool bar, menu bar, etc.)

Contributing components may also register as a factory creator of specific NavObjects. This means that if a NavObject type is requested and it does not yet exist, this component is responsible for creating it.

Component implementations for adding popup menus to NavObjects can perform several tasks. The components implement a NavContainerListener interface and implement the PopupContributor interface. When informed that a NavObject has been created (via the NavContainerListener interface), the component registers with the NavObject as a PopupContributor. As a registered PopupContributor, the component is notified when the NavObject has been right-mouse selected. The contributor at this point can add any additional popup menu items and register the associated action listeners. If a popup menu item is selected by the user, all registered action listeners are notified.

All NavTree objects are NavObjects. NavObjects can be added at any level in the tree and are represented by their associated icon (NavObject.getIcon( ) )and name (NavObject.getName( ) ). NavObjects implement the Comparable interface to ensure that they are sorted correctly. Also associated with each NavObject is a set of view panels that are displayed when the NavObject label is selected in the NavTree.

Contributing components can provide useful content to a selected NavObject as shown in FIG. 5. In the NavObject class, a method called getViewPanelTabs( . . . ) 100 accumulates all defined view panels for the selected NavObject. This includes panels created directly by the NavObject and any panels contributed by other components. There are at least two ways for a component to create view panels for a NavObject. First, the NavObject class can be extended. When the NavObject class is extended, a method getBaseViewPanelTabs( . . . ) as depicted at 102 is implemented. The component thus can create and return view panels. Second, the component can register as a view panel contributor for a specific NavObject. Typically, this is accomplished by registering as a NavContainerListener as depicted at 104. When the specific NavObject is created (added), the contributor adds itself as a ViewPanelContributor via a NavObject method addViewPanelContributor( . . . ) as depicted at 106.

When creating view panels, the CachedViewPanelTab class is extended. This class provides a facility to cache view panel instances as they are created to save time when switching between NavObjects.

FIG. 6 illustrates an embodiment 200 of the GUI 10, configured for operation in a storage area management application. Visual components and/or other elements of the GUI 200 similar to or the same as those of the GUI 10 shown in FIG. 1 are numbered the same as shown in FIG. 1. A table 234 of data related to a currently selected tree object 238 is displayed in the view panel 20. The table 234 has a row of table objects 242 associated with table cells. (Other embodiments, of course, could include tables having more than one row.) Object 242a represents a host, object 242b represents a plurality of organizations, and object 242c represents an operating system. The table object 242c is a rendering 244 of a text description.

As previously mentioned, a NavObject represents an association between a data model and a visual component, and can be rendered in an application as a label having an icon and a name. Such labels can appear, for example, in the navigation tree 14 and/or in the panel table 234. In the present embodiment, the table object 242a is a rendering of a NavObject as a label 246 having an icon 248 and a name 250.

The label 246 also appears in the tree 14. The label 246 can be mouse-activated by a user to display context-sensitive information, for example, from a data model describing the host represented by the label 246. As exemplified in FIG. 6, the tree 14 also includes labels 252 and 254 for two organizations. The labels 246, 252 and 254 are rendered in the tree 14, for example, by the NavObjectLabel class. The label 252 includes an icon 260 and a name 262. The label 254 includes an icon 266 and a name 268. In the present embodiment, for a tree object associated with a storage device, a device name is used as a label name.

The table object 242b is a rendering of a cell class 270 in accordance with one embodiment of the present invention, as shall now be described. The class 270 in one embodiment extends the phluid packages 58, 60, 62, 64 and 66. In another embodiment, the class 270 extends Java Swing and/or other Java components.

When more than one NavObject are stored in a table cell, the cell class 270 allows the user to select a visual component for each of the stored NavObjects. Specifically and for example, two navigation objects, one associated with the organization named “R10” and another associated with the organization named “R25”, are stored in the table cell associated with the object 242b.

The two navigation objects are rendered by the cell class 270 as a label 274 in the table 234. The label 274 includes a string list 278 that includes the names 262 and 268 associated with the NavObjects. The names are separated by commas in the string list 278. The label 274 also includes the icon 260. The icon 260 in one embodiment is associated with the first NavObject in the string list. Although it may be convenient to use an icon of a first navigation object in a string list to represent all of the navigation objects in the string list, an icon of another of the navigation objects in the string list could be used in other embodiments.

By mouse-activating the label 274, a user can select a visual component for a navigation object associated with the label 274. The cell class 270 can be instantiated to produce a JLabel object with support for displaying, for example, an icon, a text string, and/or a tooltip.

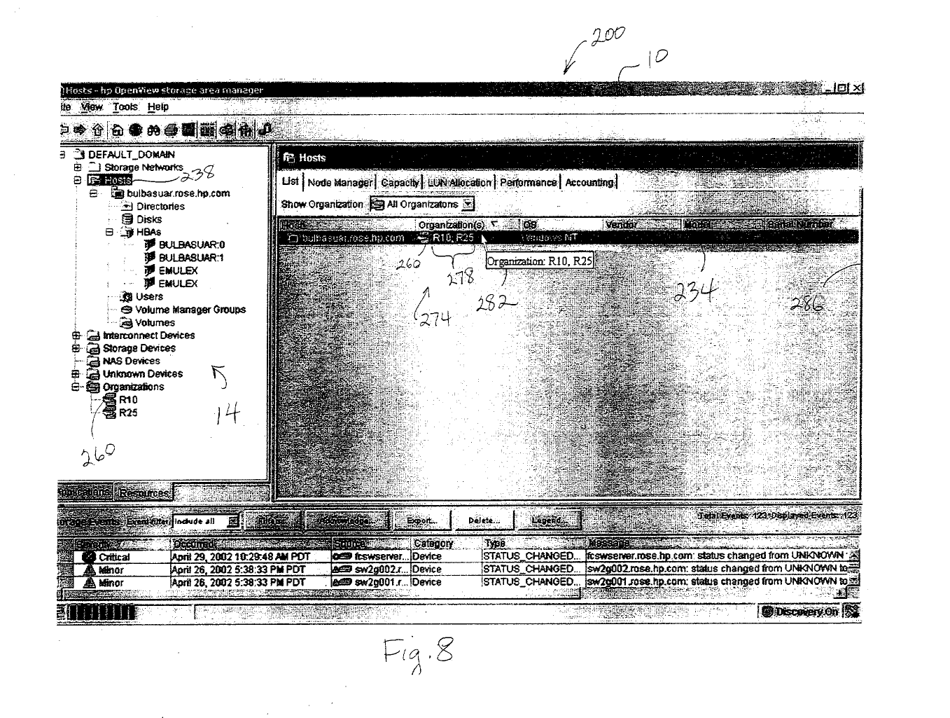

Multiple navigation objects are stored in a table cell according to a method generally indicated by reference number 502 in FIG. 7. Where it is determined 504 that one navigation object is being stored in the table cell, the cell is populated using NavObjectTableCell as described above. Where it is determined 504 that more than one navigation objects are being stored in a table cell, the cell class 270 is used to populate 506 the table cell with the navigation objects and to create pointers to each of the navigation objects. A label having an icon and a string list is rendered 508 in the table cell.

When a mouse event occurs, for example, if the user hovers or right- or left-clicks the mouse over a table cell, NavObjectTable intercepts the event. An activated NavObjectTable mouse event handler determines whether the table cell is one in which multiple navigation objects are stored. If the table cell is one in which multiple navigation objects are stored, the mouse event handler analyzes the mouse event and takes appropriate action, using the pointers created upon storage of the navigation objects in the cell. Specifically and for example, the mouse event handler displays a pull-right menu, a dialog box or a tooltip as further described below.

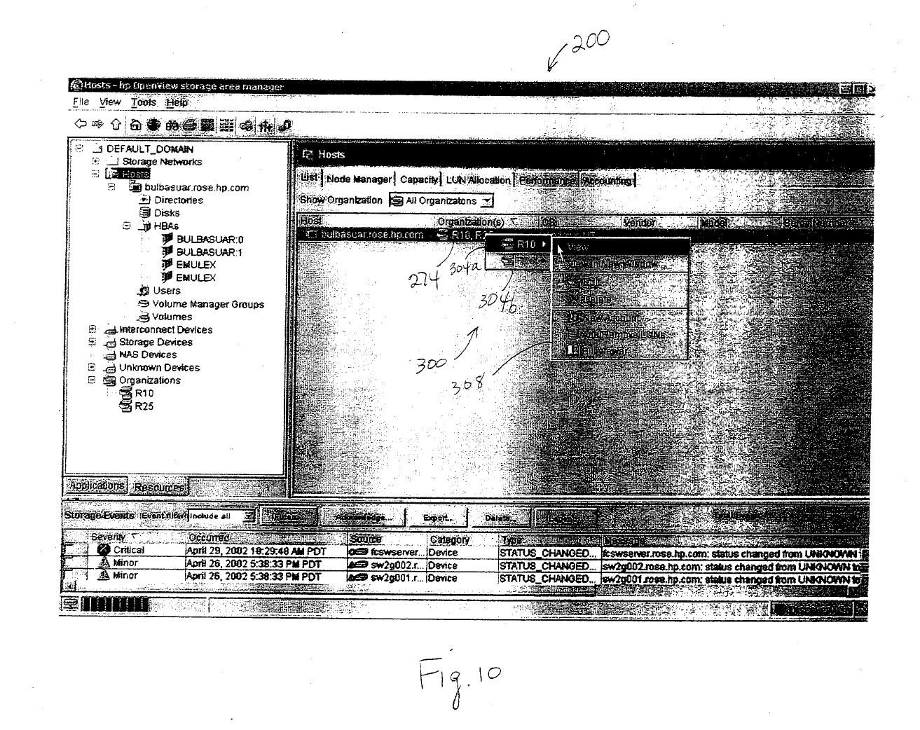

For example, referring to FIG. 8, the user may hover the mouse over the label 274 to display a tooltip 282. The tooltip 282 displays each of the names in the string list 278. The tooltip is useful, for example, for displaying all names in a string list 278 too long to be displayed in its entirety in the table object 242b.

When a tooltip is to be displayed, a Java String object defining the tooltip contents is provided to the cell class 270. To display a table cell tooltip that does not extend past an edge 286 of the GUI, a Java String object can be provided that defines the tooltip contents as a standard text string. For example, code could be provided as follows:

JLabel aLabel=new JLabel(anlcon, “This is a Label”);

String shortTooltip=“This is a ToolTip”;

aLabel.setToolTipText(shortTooltip);

When a mouse is appropriately hovered, the following tooltip appears:

This is a ToolTip

To display a tooltip in more than one line in the GUI, a Java String object is provided that defines the tooltip contents using, for example, HTML (hypertext markup language) tags embedded in a text string. The markup language coding causes the text string to be broken into multiple lines for display. For example, code could be provided as follows:

```
        JLabel aLabel = new JLabel(anlcon, “This is a Label”);
Font font = some font
String longToolTip = “<HTML><BODY style=\”“+”font-size:
“+font.getSize( )+”pt;“+”font-family: “+font.getName( )+
    “\”>This a really long ToolTip LINE 1<p style=\“”+“font-size: ″+font.getSize( )
+“pt;”+“\”>And this is LINE 2</BODY></HTML>”;
aLabel.setToolTipText(longToolTip);
```

When a mouse is appropriately hovered, the following tooltip appears:

This is a really long ToolTip LINE 1

And this is LINE 2

Thus a name list 278 that would extend past an edge 286 of the GUI can be broken into more than one line for display in the tooltip 282. It can be appreciated that the foregoing methods of providing a tooltip are not limited to use in connection with the cell class 270 and/or the UI framework, but can be practiced in a variety of other environments in which tooltips are provided in a graphical user interface. Of course, it also is possible to display a single-line tooltip using the above method.

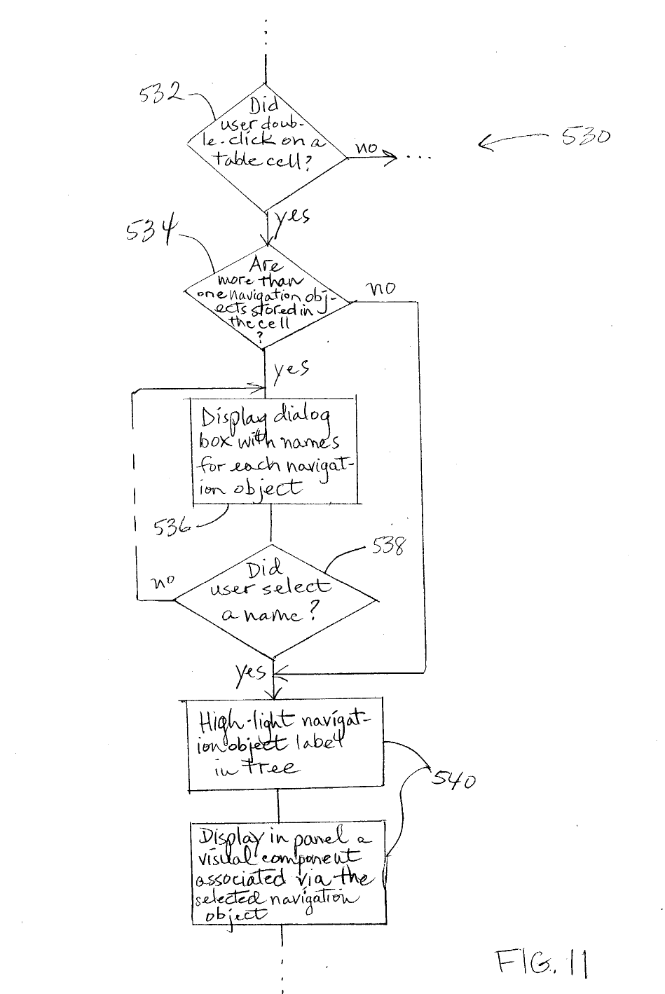

Referring to FIG. 9, a method 514 shall now be described for displaying a popup menu of context-sensitive actions for a navigation object stored in a table cell. If it is determined 516 that the user has right-mouse-clicked on the label 274, and if it is determined 518 that more than one navigation object is stored in the activated cell, the cell class 270 causes the GUI 200 to respond as shown in FIG. 10. The navigation objects in the table cell are available via the class 270 pointers. Thus, referring to FIGS. 9 and 10, a pull-right menu 300 is displayed 520 that includes pull-right menu items 304, one menu item 304 for each navigation object rendered in the table cell associated with the table object 242b. When it is determined 522 that the user has selected a pull-right item 304, a context-sensitive popup menu associated with the selected navigation object is displayed 524.

As shown in FIG. 10, the user has right-mouse-clicked on menu item 304a for the navigation object associated with the organization named “R10”, which prompts the appearance of a popup menu 308. In the present embodiment, the menu 308 is the previously described context-sensitive popup menu for the navigation object associated with the organization named “R10”. Thus the user can select from the same context-sensitive actions as would be available, for example, if the navigation object associated with the organization named “R10” were stored alone in a table cell.

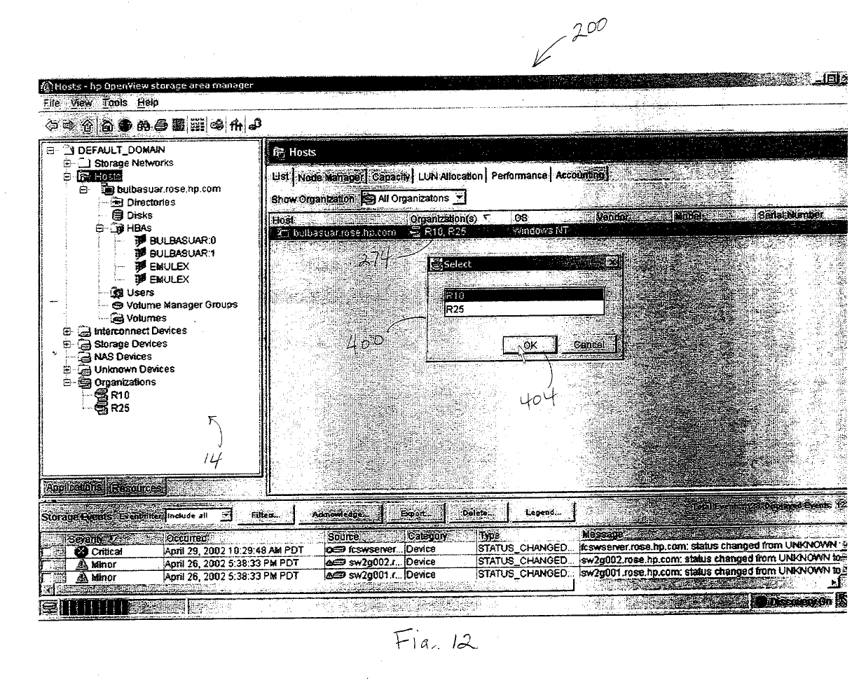

Referring to FIG. 11, a method 530 shall now be described for displaying a visual component associated with a data model via a navigation object. It is determined 532 whether a user has double-clicked on a table cell and, if so, whether 534 more than one navigation objects are stored in the cell. If more than one navigation objects are stored in the cell, the navigation objects in the table cell are available via the class 270 pointers. A dialog box containing names for each navigation object is displayed 536. When it is determined 538 that the user has selected a name from the box, one or more visual components associated with the selected navigation object are displayed 540.

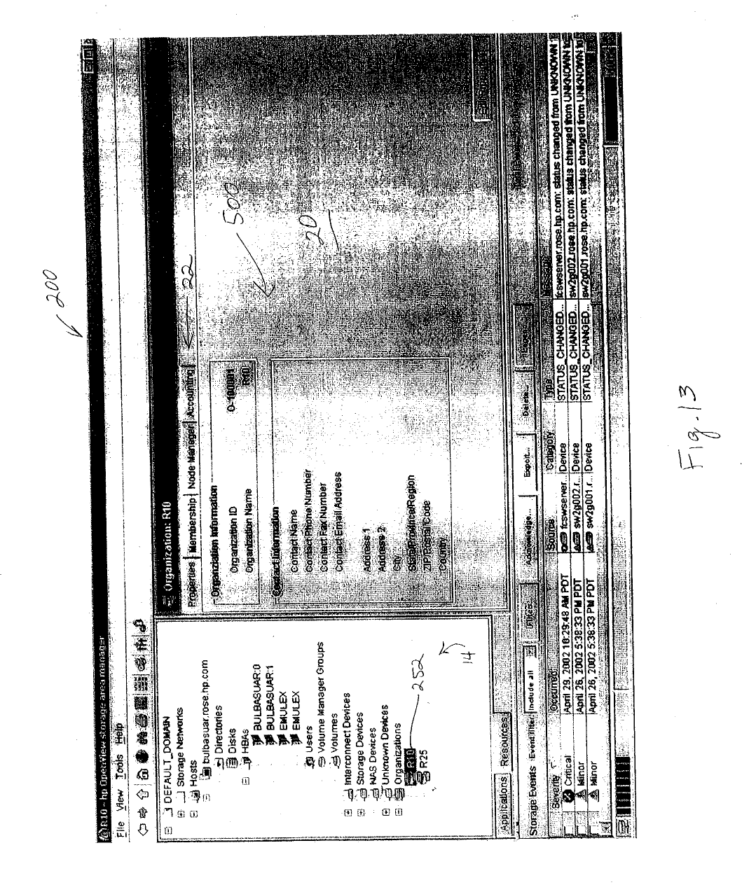

For example, when the user double-mouse-clicks on the multiple-navigation-object label 274, the cell class 270 causes the GUI 200 to respond as shown in FIG. 12. A navigation object selection dialog box 400 is displayed, from which the user can use the mouse to select a name associated with a navigation object. As exemplified in FIG. 12, the user has selected the name “R10” and is about to click on an “OK” button 404 to confirm the selection.

When the user has selected a name associated with a navigation object as shown in FIG. 12, the cell class 270 causes the GUI 200 to respond, for example, as shown in FIG. 13. The navigation tree 14 indicates that the navigation object associated with the name “R10” has been selected, and thus the label 252 is highlighted in the tree 14. In the view panel 20 is displayed a visual component 500 associated with the currently selected “R10” navigation object. In the present embodiment, the visual component 500 is the previously described panel display component for the navigation object associated with the organization named “R10”. As previously described, panel tabs 22 allow the user to select from a plurality of panels provided by the UI for the present application. Thus the user can display the same panel information as would be available, for example, if the navigation object associated with the organization named “R10” were stored alone in a table cell.

The foregoing class 270 can be seen to embody a computer-implemented method of allowing a user to select a visual component for one of a plurality of navigation objects stored in a table cell. Specifically, a string list representing the navigation objects is included in a label in the table cell, and the user is allowed to use the label to select one of the navigation objects. The class 270 uses pointers to the navigation objects to allow the user to select one of the navigation objects.

An object of the cell class 270, when rendered in a table cell for a plurality of navigation objects, enables a user to select one of the navigation objects via the table cell. The user can be provided with visual components, including but not limited to tree lists and panel displays, for the selected navigational object, in the same or similar ways in which information would be displayed were the navigation object stored singly in and selected from a table cell. Thus the user can navigate directly from the table to view information pertinent to the selected navigation object.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A computer-implemented method of allowing a user to select a visual component for one of a plurality of navigation objects in a table cell, the method comprising using a label and pointers to the navigation objects to allow the user to select one of the navigation objects.

2. The method of claim 1 further comprising creating the pointers when the navigation objects are stored in the cell.

3. The method of claim 1 further comprising determining whether the cell includes one or a plurality of navigation objects, the determining performed using a mouse event handler.

4. The method of claim 1 further comprising selecting a visual context for the navigation objects based on a mouse event.

5. The method of claim 4 wherein the visual context comprises one of a menu, a tooltip, and a dialog box.

6. The method of claim 1 wherein using a label comprises representing the navigation objects in a string list in a label.

7. The method of claim 6 further comprising including in the label an icon associated with one of the navigation objects.

8. The method of claim 1 wherein to allow the user to select comprises to display a menu including a name for each of the navigation objects.

9. The method of claim 1 wherein to allow the user to select comprises to display a visual context selected by the user.

10. A computer-readable medium containing instructions for causing a computer system to perform the method of claim 1.

11. A computer system including components to perform the method of claim 1.

12. A data display system comprising a computer and a memory configured to display data using a graphical user interface (GUI), to associate a data model with at least one visual component of the GUI using a navigation object, and to store a plurality of navigation objects in a table cell;
the display system further configured to display a visual component for one of the navigation objects using a pointer to the navigation object.

13. The system of claim 12 further configured to produce a label including a string list representing the navigation objects.

14. The system of claim 13 wherein a data model includes a model for a device, and to produce a label comprises to include in the string list a device name for each navigation object.

15. The system of claim 13 wherein a data model includes a model for an organization, and to produce a label comprises to include in the string list an organization name for each navigation object.

16. The system of claim 13 wherein to produce a label further comprises to include in the label an icon associated with one of the navigation objects.

17. The system of claim 12 wherein a visual component comprises at least one of a tooltip, a tree, and a panel.

18. The system of claim 12 wherein a visual component comprises a tooltip having a text string defined using a markup language.

19. The system of claim 12 wherein to display a visual component comprises to display a visual context selected by a user using a label.

20. The system of claim 19 wherein to display a visual context comprises to display one of the group of a menu, a tooltip, and a dialog box.

21. The system of claim 19 wherein to display a visual context comprises displaying a tooltip having a text string defined using a markup language.

22. A computer-readable medium comprising computer-readable instructions for using a label and pointers to a plurality of navigation objects in a table cell of a graphical user interface (GUI) to allow a user of the GUI to select a visual component via one of the navigation objects.

23. The medium of claim 22 further comprising computer-readable instructions for rendering a cell object in the table cell to associate one of the navigation objects with a visual component.

24. The medium of claim 22 further comprising computer-readable instructions for allowing a user to use the label to select a visual component.

25. The medium of claim 24 wherein allowing a user comprises associating a data model with a visual component via the one of the navigation objects.

26. The medium of claim 22 further comprising computer-readable instructions for selecting a visual context from the group of a tooltip, a menu and a dialog box.

27. The medium of claim 22 wherein a visual component includes a tooltip, the medium further comprising computer-readable instructions for defining the tooltip using a markup language.

28. The medium of claim 22 further comprising computer-readable instructions for associating an icon with one of the navigation objects.

29. The medium of claim 22 further comprising computer-readable instructions for including in the label a string list including a name associated with a data model.

30. A computer-readable medium comprising computer-readable instructions for displaying a tooltip in a graphical user interface (GUI), the instructions configured to define a content for the tooltip using a markup language.

31. The medium of claim 30 wherein to define a content comprises to embed markup language tags in a text string.

32. The medium of claim 31 wherein to define a content comprises to break up a text string for display in more than one line.

33. The medium of claim 30 wherein the markup language comprises hypertext markup language (HTML).

34. A computer program product for use on a computer system for displaying data using a graphical user interface (GUI), the product comprising a computer readable medium having computer-readable code thereon, the code including a cell class configured, when rendered in a table cell including a plurality of navigation objects, to use a label and pointers to the navigation objects to allow a user to select a visual component for one of the navigation objects.

35. The computer program product of claim 34 further configured to include in the label a string list representing the navigation objects.

36. The computer program product of claim 35 wherein each navigation object is associated with a data model for a device, the string list comprising a device name for each navigation object.

37. The computer program product of claim 35 wherein each navigation object is associated with a data model for an organization, the string list comprising an organization name for each navigation object.

38. The computer program product of claim 34 wherein a visual component comprises a tooltip.

39. The computer program product of claim 38 wherein the tooltip comprises a text string defined using a markup language.
